(19) United States
(12) Patent Application Publication
(10) Pub. No.: US 2025/0306396 A1
(43) Pub. Date: Oct. 2, 2025

(54) DUAL-AXIS HINGE ASSEMBLY FOR A HEAD-MOUNTED WEARABLE DEVICE

(71) Applicant: GOOGLE LLC, Mountain View, CA (US)

(72) Inventors: Coulter Eastwood, Kitchener (CA); Eric Bokides, Boise, ID (US); Michael Webb, Scotts Valley, CA (US); Sheng-Kai Chang, Taipei City (TW)

(21) Appl. No.: 18/621,310

(22) Filed: Mar. 29, 2024

(51) Int. Cl. G02C 5/22; G02B 27/01

(52) U.S. Cl. CPC G02C 5/2263; G02B 27/0176; G02B 2027/0178

(57) ABSTRACT

A head-mounted wearable device (HMWD), such as a set of augmented reality (AR) and/or virtual reality (VR) binocular smart glasses may include a dual-axis hinge mechanism. The dual-axis hinge mechanism includes a first hinge positioned between a frame and a first support structure of a temple arm, enabling hinged pivoting of the temple arm. Additionally, a second hinge is positioned between the first support structure of the temple arm and a second support structure of the temple arm. This configuration allows for enhanced flexibility and adjustability of the HMWD, thereby facilitating comfortable and secure positioning on the user's head.

### BACKGROUND

A head-mounted wearable device (HMWD), such as a set of augmented reality (AR) and/or virtual reality (VR) binocular smart glasses often requires the angular deflection or movement around the y-axis (vertical axis) to be limited to approximately 5 milliradians between a left waveguide and a right waveguide to effectively mitigate binocular disparity. Binocular disparity is a natural phenomenon resulting from the horizontal separation of the eyes. For example, when the left and right waveguides exhibit too much deflection or misalignment, it can lead to perceptual differences between the images seen by each eye, causing discomfort, eyestrain, and a reduced sense of depth. In the context of smart glasses and similar optical devices, minimizing binocular disparity may provide users with a more accurate and comfortable visual experience.

A prevailing strategy employed to minimize deflection currently involves the rigidization of the front frame. For example, some binocular smart glasses employ a rigid front frame and incorporate a hinge with a single axis of rotation. The single axis of rotation in standard eyewear is typically configured to pivot the arms of the standard eyewear in an open and closed orientation and may facilitate controlled over flex. However, incorporating such a design paradigm into smart glasses gives rise to undesirable aesthetic challenges, falling short of meeting industrial design standards. Moreover, this approach fails to address the intricate routing of flexible printed circuits (FPCs) through the hinge mechanism. It would be more desirable for an over flexibility in the hinges of binocular smart glasses to accommodate a diverse range of head widths while concurrently minimizing deflection within the binocular display sub-assembly.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a sectional view of a dual-axis hinge mechanism with a first hinge and a second hinge configured to be implemented in a set of AR glasses in accordance with some embodiments.

FIG. 2 is a diagram illustrating a side view of a second hinge of the dual-axis hinge mechanism of FIG. 1 including a first protrusion removably connected to a portion of a first limit wall of the first support structure when a resilient member is extended in accordance with some embodiments.

FIG. 3 is a diagram illustrating a side view of a secondary axis of the dual-axis hinge mechanism of FIGS. 1 and 2 including a second protrusion removably connected to a portion of a second limit wall of the first support structure when a resilient member is depressed by a force of a user to hingedly pivot the temple arm in the direction of the force in accordance with some embodiments.

FIG. 4 is a diagram illustrating a rear perspective view of the dual-axis hinge mechanism of FIGS. 1-3 implemented in a set of AR glasses in accordance with some embodiments.

### DETAILED DESCRIPTION

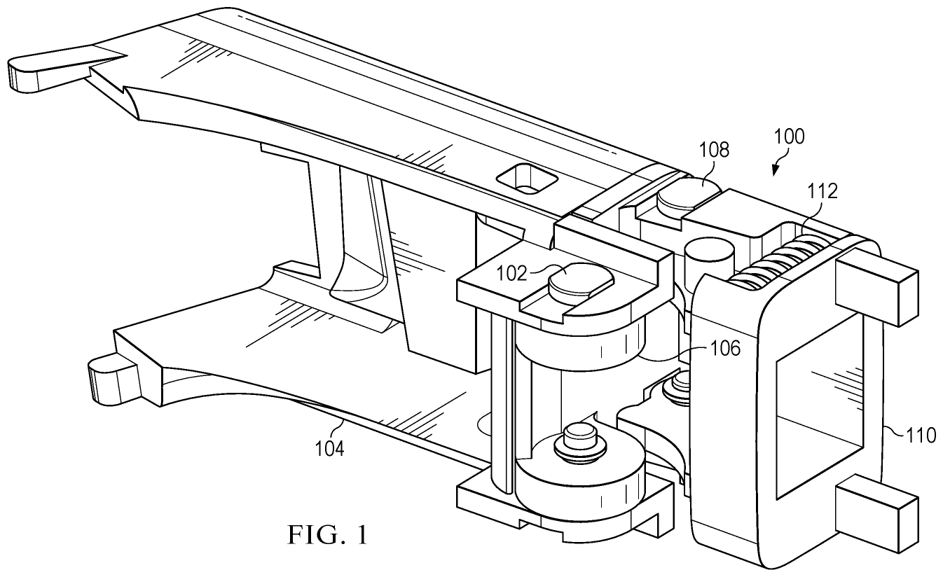

FIGS. 1-4 illustrate an example system for employing a dual-axis hinge mechanism in a HMWD such as a set of AR glasses. The introduction of a secondary axis of rotation facilitates independent over flexion of the temple, decoupled from the primary hinge axis governing the opening and folding of the glasses. The dual-axis hinge mechanism facilitates the integration of FPCs through the hinge area, enabling force control of the temple arms when the glasses are worn by a user. An advantage of this design lies in its capacity for precise control. The imposition of volume constraints poses considerable challenges in realizing a similar level of control with a single point of location. The incorporation of a secondary axis addresses these challenges, ensuring enhanced functionality and control in the operation of the glasses.

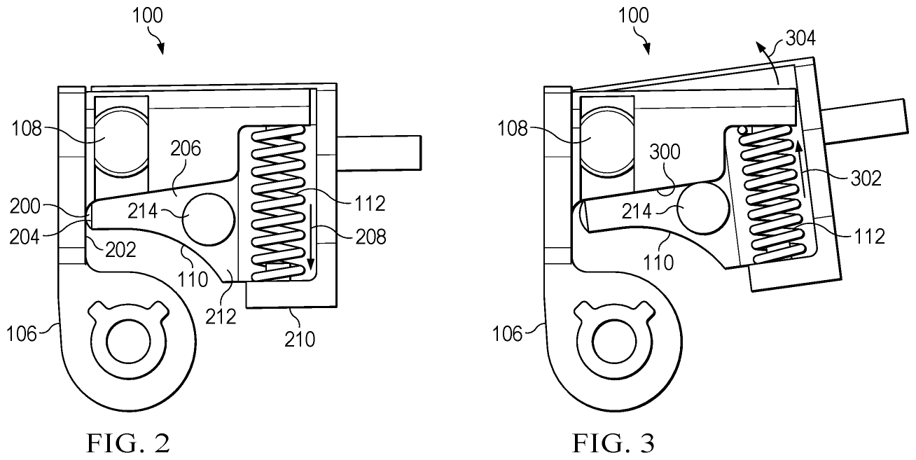

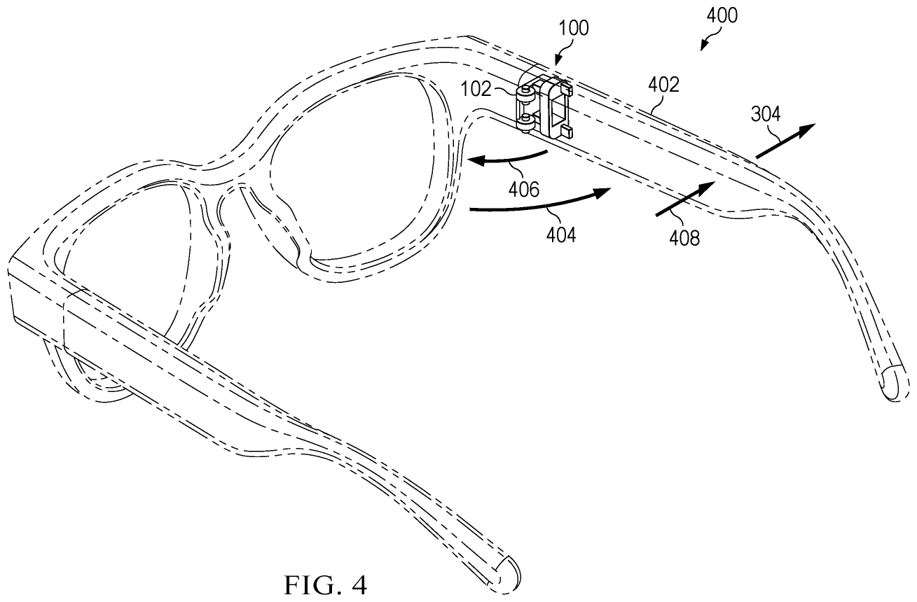

FIG. 1 illustrates a dual-axis hinge mechanism 100 for beneficial use in AR/VR systems utilizing a binocular glasses form factor in accordance with some embodiments. The dual-axis hinge mechanism 100 includes a first hinge 102 disposed between a frame 104 and first support structure 106 of a temple arm (see FIG. 4). The temple arm is configured to hingedly pivot about the axis of the first hinge 102. The first hinge 102 may include the first support structure 106 to have a set of barrel hinges interlocked with one or more fasteners, such as a screw, to create a pivot point. The first hinge 102 is configured to hingedly pivot the temple arm in an opened and a closed orientation. The dual-axis hinge mechanism 100 has second hinge 108. The second hinge 108 is disposed between the first support structure 106 of the temple arm and a second support structure 110 of the temple arm. The second hinge 108 of the dual-axis hinge mechanism 100 utilizes a resilient member 112 including any deformable material that has the ability to deform when subjected to an external force and then return to its original shape when the force is removed including, but not limited to, a coil spring, a leaf spring, a pliable damper, an elastomeric band, a pliable cord, and/or foam configured to control the direction of one or more limit structures, such as protrusions, configured to restrict movement of the second support structure 110 of the temple arm as it pivots about the axis of the second hinge 108, as shown and described below with reference to FIGS. 2 and 3.

FIG. 2 illustrates the dual-axis hinge mechanism 100 of FIG. 1 including a first protrusion 200 removably connected to a portion of a first limit wall 202 of the first support structure 106 when the resilient member 112 is at a maximum extended position to apply a force 208 to a portion of the second support structure 110. A first end of the resilient member 112 is connected to a portion of the first support structure 106 and a second end of the resilient member 112 is connected to a portion of the second support structure. The portion of the second support structure 110 that receives the force 208 may include a flange 210. The flange 210 is perpendicular to a second side 212 of the first wall 206 of the second support structure 110. The first protrusion 200 extends from a first side 204 of a first wall 206 of the second support structure 110. A second protrusion 214 extends from the second side 212 of the first wall 206 of the second support structure 110 and is configured to limit the movement of the second support structure 110 as shown in FIG. 3.

FIG. 3 illustrates the dual-axis hinge mechanism 100 of FIGS. 1 and 2 with the second protrusion 214 removably connected to a portion of a second limit wall 300 of the first support structure 106. For example, the second protrusion 214 is configured to be removably connected to the portion of the second limit wall 300 when the resilient member 112 is at a maximum depressed position by the counter force 302 of the second support structure 110. When the resilient member 112 is depressed by a counter force 302 of the second support structure 110, the second support structure 110 is configured to hingedly pivot at second hinge 108. The second support structure 110 is oriented an over flexion direction 304 being substantially parallel with the direction of the counter force 302. The counter force 302 may be applied by a force of a user's head (not shown) being pressed against the second support structure 110 when a HMWD of FIG. 4, is worn by a user.

FIG. 4 illustrates a HMWD such as a set of AR glasses 400 that implement the dual-axis hinge mechanism 100 of FIGS. 1-3. The first hinge 102 is configured to pivot the temple arm 402 in an opened orientation 404 and/or a closed orientation 406. The introduction of the secondary axis of rotation at the second hinge of the dual-axis hinge mechanism 100 facilitates independent over flexion of the temple arm 402 at the over flexion direction 304 being substantially parallel with the direction of the counter force applied, for example, by a force 408 of a user's head (not shown) pressing against the temple arm 402.

As a general summary, the dual-axis hinge mechanism 100 may improve rigidity in the set of AR glasses 400, by effectively mitigating binocular disparity. Typically, binocular disparity results from the separation of the eyes and may lead to perceptual differences between images seen by each eye if the angular deflection around the y-axis (vertical axis) exceeds approximately 5 milliradians. This misalignment can cause discomfort, eyestrain, and a diminished sense of depth. To address this, the dual-axis hinge mechanism 100 offers an enhanced solution in which the first hinge 102 allows the temple arm 402 to pivot in both an opened orientation 404 and/or a closed orientation 406. The introduction of the secondary axis of rotation at the second hinge 108 facilitates independent over flexion of the temple arm 402. This over flexion, parallel to the direction of the counter force applied by a user's head pressing against the temple arm 402, improves rigidity and minimizes the risk of excessive deflection or misalignment.

As noted, in at least one embodiment the over flexion in the dual-axis hinge mechanism 100 refers to a deliberate flexibility incorporated into the temple arm 402 of the set of AR glasses 400. This intentional flexibility is designed to allow controlled movement specifically in a direction parallel to the counter force 302 applied by a user's head pressing against the temple arm. By permitting over flexion parallel to the direction of the counter force 302, the dual-axis hinge mechanism 100 addresses the forces exerted by the user's head during wear. This design feature enhances rigidity in several ways. Firstly, it ensures that the movement of the temple arm is predictable and controlled, preventing unpredictable shifts or misalignments. The controlled over flexion serves to distribute forces evenly along the temple arm 402, mitigating localized stress concentrations. This distribution may maintain the structural integrity of the set of AR glasses 400 and may prevent potential issues associated with excessive strain or deflection. Moreover, the intentional over-flexion may contribute to enhanced comfort for the user. For example, the second hinge 108 allows the temple arm 402 to yield slightly to the pressure applied by the user's head, minimizing the risk of pressure points that may arise from rigid structures. The deliberate flexibility of the temple arm absorbs and accommodates external forces, reducing the likelihood of excessive deflection or misalignment. This, in turn, ensures that the left and right waveguides stay within the recommended angular deflection range, effectively mitigating binocular disparity and enhancing the overall user experience with improved stability and comfort.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A head-mounted wearable device comprising:
a dual-axis hinge mechanism comprising:
a first hinge, the first hinge disposed between a frame and first support structure of a temple arm to hingedly pivot the temple arm; and
a second hinge, the second hinge disposed between the first support structure of the temple arm and a second support structure of the temple arm.

2. The head-mounted wearable device of claim 1, further comprising:
a resilient member having a first end connected to a portion of the first support structure and a second end connected to a portion of the second support structure, the resilient member is configured to apply a force to the portion of the second support structure.

3. The head-mounted wearable device of claim 2, wherein the portion of the second support structure that receives the force is a flange.

4. The head-mounted wearable device of claim 3, wherein the flange is perpendicular to a second side of a first wall of the second support structure.

5. The head-mounted wearable device of claim 2, wherein the resilient member is a spring.

6. The head-mounted wearable device of claim 2, wherein the resilient member is configured to hingedly pivot the second support structure in a direction of a counter force.

7. The head-mounted wearable device of claim 6, further comprising:
a first protrusion extending from a first side of a first wall of the second support structure.

8. The head-mounted wearable device of claim 7, wherein the first protrusion is configured to be removably connected to a portion of a first limit wall of the first support structure when the resilient member is at a maximum extended position.

9. The head-mounted wearable device of claim 8, further comprising:
a second protrusion extending from a second side of the first wall of the second support structure.

10. The head-mounted wearable device of claim 9, wherein the second protrusion is configured to be removably connected to a portion of a second limit wall of the first support structure when the resilient member is at a maximum depressed position by the counter force of the second support structure.
